(19) United States
(12) Patent Application Publication
(10) Pub. No.: US 2008/0105351 A1
(43) Pub. Date: May 8, 2008

(54) Extended-Mobility Tire with Lowered Anchoring Zone

(76) Inventor: Russell Shepherd, Simpsonville, SC (US)

Correspondence Address: BUCHANAN, INGERSOLL & ROONEY PC, POST OFFICE BOX 1404, ALEXANDRIA, VA, 22313-1404, US

(21) Appl. No.: 11/661,387

(22) PCT Filed: Jun. 28, 2005
(86) PCT No.: PCT/EP05/53028

§ 371 Date: May 17, 2007

(30) Foreign Application Priority Data
Aug. 31, 2004 (FR) 0409264

(51) Int. Cl. B60C 17/04

(52) U.S. Cl. 152/517

(57) ABSTRACT

Extended-mobility tire includes at least one carcass-type reinforcement structure, with each of the tire's sidewalls being reinforced by a sidewall insert. Each bead of the tire includes an anchoring zone permitting the reinforcement structure to be held on a rim and including an anchoring rubber mix with a series of circumferential cord windings. Each bead further includes a bead seat zone formed of a rubber mix of modulus ME10 which is less than that of the mix of the anchoring zone and arranged radially internally of the anchoring zone. The bead seat zone physically separates the anchoring zone from the seat of the rim when the tire is mounted. The bead seat zone has a maximum thickness of 2.8 mm, and is preferably equal to or less than 2.2. mm. This arrangement makes it possible to increase the tire's lateral rigidity, without adversely affecting the intrinsic properties of the tire's rim zone and/or the sidewalls.

### BACKGROUND

The present invention relates to an extended-mobility tires of the type having self-supporting sidewalls, whose characteristics of wedging against the flange or hook of a corresponding rim are optimum, thus contributing to improved the characteristics of travel in degraded (low or zero pressure) mode.

For some years, tire manufacturers have been devoting particularly great effort to developing original solutions to a problem dating back to the very first time use was made of wheels fitted with tires of the inflated type, namely how to allow the vehicle to continue on its journey despite a considerable or total loss of pressure in one or more tires. For decades, the spare wheel was considered to be the sole, universal solution. Then, more recently, the considerable advantages linked to the possible elimination thereof have become apparent. The concept of “extended mobility” is being developed. The associated techniques allow travel to continue with the same tire, within certain limits, after a puncture or a drop in pressure. This allows the driver to travel to a repair point, for example, without having to stop, in frequently dangerous circumstances, to fit the spare wheel.

Two major types of extended-mobility technology are currently available on the automobile market. On the one hand, there are tires of the self-supporting type (often known by their abbreviation ZP, standing for “zero pressure”). Self-supporting tires are capable of bearing a load under reduced pressure, or indeed without pressure, thanks to sidewalls which are reinforced, most frequently by means of inserts of rubber material provided in the sidewalls.

On the other hand, wheels are available which are equipped with supports capable of supporting the inside of the tread of a tire in the event of sagging of the sidewalls following a drop in pressure. This solution is advantageously combined with a tire comprising a radially inner bottom zone or rim zone capable of minimising the risk of the tire sliding out of the rim. This solution is advantageous since it makes it possible to keep substantially intact the characteristics of travel under normal conditions. On the other hand, it has the drawback of requiring an additional component, i.e., the support, for each of the wheels of the vehicle.

In order to produce tires having self-supporting sidewalls of a high level of quality and reliability, it is desirable to be able to provide characteristics of travel in degraded mode (that is to say at low or zero pressure) which are as advantageous as possible, in particular as far as the radius of action is concerned. One of the key points making it possible to increase the operating range of this type of product lies in controlling the phenomena of unwedging. This is because, during travel in degraded mode, the stresses experienced at the rim/bottom zone interface of the tire are extreme, and buckling of the sidewall results in a great tendency of the bottom zone of the tire to attempt to slip against the rim flange.

Several solutions for attempting to overcome this type of problem are known today. For example, conventionally, in order to increase the lateral rigidity of a tire of self-supporting type, conventionally a sidewall insert is used which is thicker and/or made with a material whose modulus of extension is higher than the reference one.

However, these various solutions do not always make it possible to optimise the other properties of the product. Now, for certain products, in particular top-of-the-range ones, it is desirable to be able to obtain better compromises between the characteristics of the tire. In particular, it is desired to act so as to reduce the susceptibility to unwedging during travel at low or zero pressure, while best maintaining the qualities of comfort.

Furthermore, a tire of type 225/50R17 ZCY (see FIG. 1), designed by the present assignee, is known which comprises, in the bottom zone, a seat zone, radially internally to the anchoring zone: this zone, conventionally, has a thickness of greater than 4 mm. In this example, it has a thickness of 4.7 mm.

### SUMMARY OF INVENTION

To overcome these various drawbacks, the invention proposes a tire suitable for extended-mobility travel, comprising at least one carcass-type reinforcement structure anchored on each side of said tire in a bead the base of which is intended to be mounted on a rim seat, each of said beads extending substantially radially externally in the form of sidewalls, the sidewalls radially towards the outside joining a tread, the carcass-type reinforcement structure extending circumferentially from the bead towards said sidewall, a crown reinforcement, each of said sidewalls being reinforced by a sidewall insert formed of rubber composition capable of bearing a load corresponding to part of the weight of the vehicle in a situation in which the inflation pressure is substantially reduced or zero, each of the beads furthermore comprising an anchoring zone permitting the reinforcement structure to be held and comprising on one hand an anchoring rubber mix and on the other hand a series of circumferential cord windings arranged in said rubber mix on either side of the end portion of the reinforcement structure, a bead seat zone, formed of a rubber mix having a secant modulus of extension at 10% deformation, measured at 23° C. in accordance with Standard ASTM D 412, less than that of the mix of the anchoring zone, being arranged radially internally to the anchoring zone, and makes it possible to separate said anchoring zone from the seat of the rim when the tire is mounted, said zone having a maximum thickness of 3.0 mm, and preferably equal to or less than 2.5 mm.

This type of arrangement makes it possible to increase the torsional rigidity without adversely affecting the intrinsic properties of the bottom zone and/or the sidewalls, as is the case for example when using a thicker sidewall insert. Due to this solution, the susceptibility to unwedging when travelling at low or zero pressure is reduced.

Advantageously, said anchoring zone comprises, in its radially inner portion, a portion free of circumferential cords.

On the other hand, the anchoring zone advantageously comprises, in its radially inner portion, a portion free of reinforcement structure. Advantageously, the portion free of circumferential cords extends radially over a greater distance relative to the portion free of reinforcement structure wires.

Said seat zone preferably forms a band of substantially constant thickness over more than one quarter of the radial width of the anchoring zone.

Advantageously, the rubber mix of the anchoring zone is formed of a rubber composition having a secant modulus of extension ME10 at 10% deformation, measured at 23° C. in accordance with Standard ASTM D 412, greater than 10 MPa, and preferably between 30 and 60.

Advantageously, said rubber mix of the seat zone is formed of a rubber composition having a secant modulus of extension ME10 at 10% deformation, measured at 23° C. in accordance with Standard ASTM D 412, of from 5 to 15 MPa, and preferably between 6 and 9. In the example illustrated in FIG. 2, this modulus is 7.5 MPa.

Advantageously, said sidewall insert is arranged axially internally relative to said reinforcement structure. The reinforcement structure is then arranged axially externally, thus optimising its course in the tension zone. This is particularly beneficial in terms of endurance.

According to one advantageous embodiment of the tire according to the invention, each of said sidewall inserts is preferably formed of a rubber composition having a secant modulus of extension ME10 at 10% deformation, measured at 23° C. in accordance with Standard ASTM D 412, of from 5 to 13 MPa.

Preferably, each of said sidewall inserts has a thickness of from 3 mm to 20 mm, and preferably from 5 mm to 14 mm.

### BRIEF DESCRIPTION OF THE DRAWINGS

All the details of a preferred embodiment are given in the following description, supplemented by the attached FIGS. 1 and 3, in which:

FIG. 1 illustrates a radial section showing essentially a bead, a sidewall and half of the crown of a preferred embodiment of a known type of tire, the bead seat zone of which has a maximum thickness of 4.7 mm;

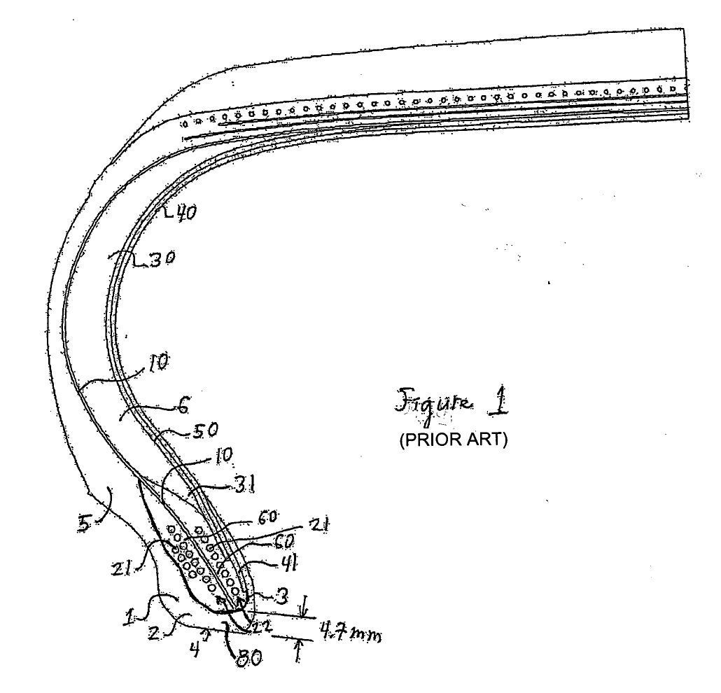

FIG. 2 illustrates a radial section showing essentially a bead, a sidewall and half of the crown of an example of embodiment of a type of tire according to the invention, which is similar in numerous respects to that of FIG. 1, but the bead seat zone of which has a maximum thickness of 2.0 mm;

FIG. 3 illustrates a radial section showing essentially a bead, a sidewall and half of the crown of a variant of the preferred embodiment of the tire illustrated in FIG. 2, the bead seat zone of which has a maximum thickness of 2.0 mm.

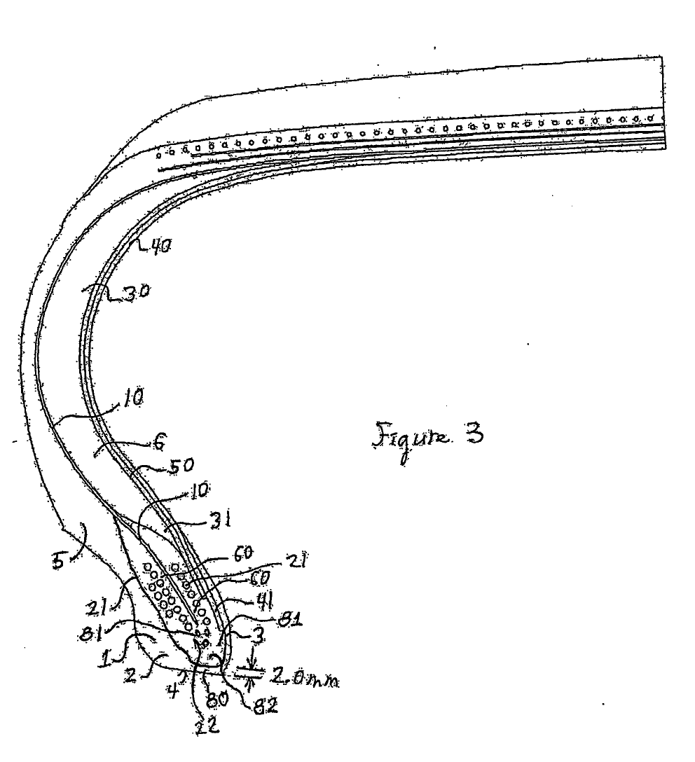

### DETAILED DESCRIPTION PREFERRED EMBODIMENTS

The reinforcement armature or reinforcement of the tires is currently—and most frequently—constituted by stacking one or more plies conventionally referred to as “carcass plies”, “crown plies”, etc. This manner of designating the reinforcement armatures is derived from the manufacturing process, which consists of producing a series of semi-finished products in the form of plies, provided with cord reinforcing threads which are frequently longitudinal, which plies are then assembled or stacked in order to build a tire blank. The plies are produced flat, with large dimensions, and are subsequently cut according to the dimensions of a given product. The plies are also assembled, in a first phase, substantially flat. The blank thus produced is then shaped to adopt the toroidal profile typical of tires. The semi-finished products referred to as “finishing” products are then applied to the blank, to obtain a product ready to be vulcanised.

Such a “conventional” type of process involves, in particular for the phase of manufacture of the blank of the tire, the use of an anchoring element (generally a bead wire), used for anchoring or holding the carcass reinforcement in the zone of the beads of the tire. Thus, in this type of process, a portion of all the plies constituting the carcass reinforcement (or of only a part thereof is turned up around a bead wire arranged in the bead of the tire. In this manner, the carcass reinforcement is anchored in the bead.

The general adoption of this type of conventional process in the industry, despite the numerous different ways of producing the plies and assemblies, has led the person skilled in the art to use a vocabulary which reflects the process; hence the generally accepted terminology, comprising in particular the terms “plies”, “carcass”, “bead wire”, “shaping”, to designate the change from a flat profile to a toroidal profile, etc.

However, there are nowadays tires which do not, properly speaking, comprise “plies” or “bead wires” in accordance with the preceding definitions. For example, document EP 0 582 196 describes tires manufactured without the aid of semi-finished products in the form of plies. For example, the cords of the different reinforcement structures are applied directly to the adjacent layers of rubber mixes, the whole being applied in successive layers on a toroidal core having a shape which makes it possible to obtain directly a profile similar to the final profile of the tire being manufactured. Thus, in this case, there are no longer any “semi-finished products”, nor “plies”, nor “bead wires”. The base products, such as the rubber mixes and reinforcing threads in the form of cords or filaments, are applied directly to the core. As this core is of toroidal form, the blank no longer needs to be shaped in order to change from a flat profile to a profile in the form of a torus.

Furthermore, the majority of the examples of embodiment of tires described in this document do not have the “conventional” upturn of the carcass ply around a bead wire. In these examples, this type of anchoring is replaced by an arrangement in which circumferential filaments are arranged adjacent to said sidewall reinforcement structure, the whole being embedded in an anchoring or bonding rubber composition.

There are also processes for assembly on a toroidal core using semi-finished products specially adapted for quick, effective and simple laying on a central core. Finally, it is also possible to use a mixture comprising both certain semi-finished products to produce certain architectural aspects (such as plies, bead wires, etc.), whereas others are produced from the direct application of mixes and/or reinforcing threads in the form of filaments or strips.

In the present document, in order to take into account recent technological developments both in the field of manufacture and in the design of products, the conventional terms such as “plies”, “bead wires” etc. are advantageously replaced by neutral terms or terms which are independent of the type of process used. Thus, the term “carcass-type reinforcing thread” or “sidewall reinforcing thread” is valid as a designation for the reinforcement cords of a carcass ply in the conventional process, and the corresponding cords, generally applied at the level of the sidewalls, of a tire produced in accordance with a process without semi-finished products. The term “anchoring zone”, for its part, may equally well designate the “traditional” upturn of a carcass ply around a bead wire of a conventional process or the assembly formed by the circumferential filaments, the rubber composition and the adjacent sidewall reinforcement portions of a bottom zone produced with a process with application to a toroidal core.

In the present description, the term “cord” very generally designates equally well monofilaments and multifilaments, or assemblies such as cables, plied yarns or alternatively any equivalent type of assembly, and this whatever the material and the treatment of these cords. This may, for example, involve surface treatments, coating or pre-sizing in order to promote adhesion to the rubber. The expression “unitary cord” designates a cord formed of a single element, without assembling. The term “multifilament”, in contrast, designates an assembly of at least two unitary elements to form a cable, plied yarn etc.

“Characteristics of the cord” is understood to mean, for example, its dimensions, its composition, its characteristics and mechanical properties (in particular the modulus), its chemical characteristics and properties, etc.

In the present description, “contact” between a cord and a layer of bonding rubber is understood to mean the fact that at least part of the outer circumference of the cord is in intimate contact with the rubber composition constituting the bonding rubber.

It is known that, conventionally, the carcass ply or plies is/are turned up about a bead wire. The bead wire then performs a carcass anchoring function. Thus, in particular, it withstands the tension which develops in the carcass cords for example under the action of the inflation pressure. The arrangement described in the present document makes it possible to provide a similar anchoring function. It is also known to use the bead wire of conventional type to perform the function of clamping the bead on a rim. The arrangement described in the present document also makes it possible to provide a similar clamping function.

“Sidewalls” refers to the portions of the tire, most frequently of low flexural strength, located between the crown and the beads. “Sidewall mix” refers to the rubber mixes located axially externally relative to the cords of the reinforcement structure of the carcass and to their bonding rubber. These mixes usually have a low elasticity modulus.

“Bead” refers to the portion of the tire adjacent radially internally to the sidewall.

“Modulus of extension ME10” of a rubber composition is understood to mean an apparent secant modulus of extension obtained at a uniaxial deformation of extension of the order of 10% measured at 23° C. in accordance with Standard ASTM D 412.

As a reminder, “radially upwards” or “radially upper” or “radially externally” means towards the largest radii.

A carcass-type reinforcement or reinforcing structure will be said to be radial when its cords are arranged at 90°, but also, according to the terminology in use, at an angle close to 90°.

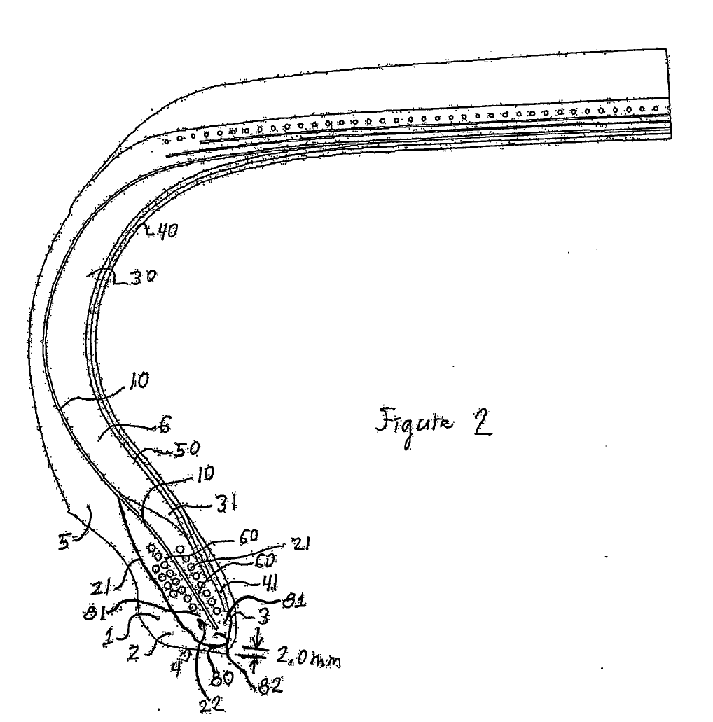

FIG. 2 shows the bottom zone, in particular the bead 1, of a tire according to the invention. The bead 1 comprises an axially outer portion 2 which is provided and shaped so as to be placed against the flange of a rim. The upper portion, or radially outer portion, of the portion 2 forms a portion 5 adapted to the rim hook. This portion is frequently curved axially towards the outside, as illustrated in FIG. 2. The portion 2 ends radially and axially towards the inside in a bead seat 4 which is adapted to be placed against a rim seat. The bead also comprises an axially inner portion 3, which extends substantially radially from the seat 4 towards the sidewall 6.

The tire also comprises a carcass-type reinforcement or reinforcing structure 10 provided with reinforcing threads which are advantageously configured in a substantially radial arrangement. This structure may be arranged continuously from one bead to the other, passing through the sidewalls and the crown of the tire, or alternatively it may comprise two or more parts, arranged for example along the sidewalls, without covering the entire crown.

In order to position the reinforcement cords as accurately as possible, it is very advantageous to build the tire on a rigid support, for example a central core which imposes the shape of its inner cavity. There are applied to this core, in the order required by the final architecture, all the constituents of the tire, which are arranged directly in their final position, without the profile of the tire having to be modified during building.

The anchoring function is provided in particular owing to an arrangement of circumferential cords, as illustrated for example in FIG. 2. Circumferential cords 21, preferably arranged in the form of stacks 22, form an arrangement of anchoring cords, provided in each of the beads. These cords are preferably metallic, and possibly brass-coated. Various variants advantageously provide for cords which are textile in nature, such as, for example of aramid, nylon, PET, PEN, or hybrid, or of another nature, for example glass fibres. In each stack, the cords are advantageously substantially concentric and superposed.

In order to ensure perfect anchoring of the reinforcement structure, a stratified composite bead is produced. Within the bead 1, between the cord alignments of the reinforcement structure, there are arranged the circumferentially oriented cords 21. These are arranged in a stack 22 as in the drawings, or in a plurality of adjacent stacks, or in any suitable arrangement, depending on the type of tire and/or the desired characteristics.

The radially inner end portions of the reinforcement structure 10 cooperate with the cord windings. Anchoring of these portions in said beads is thus effected. In order to promote this anchoring, the space between the circumferential cords and the reinforcement structure is occupied by a bonding or anchoring rubber composition 60. It is also possible to provide for the use of a plurality of mixes having different characteristics, defining a plurality of zones, the combinations of mixes and the resultant arrangements being virtually unlimited. By way of non-limitative example, the modulus of extension of such a mix may reach or exceed 10 to 15 MPa, and even in some cases reach or even exceed 40 MPa. In the example illustrated, the modulus is 55 MPa.

The arrangements of cords may be arranged and manufactured in several ways. For example, a stack may advantageously be formed of a single cord wound (substantially at zero degrees) in a spiral over several turns, preferably from the smallest diameter towards the largest diameter. A stack may also be formed of a plurality of concentric cords laid one in another, so that rings of gradually increasing diameter are superposed. It is not necessary to add a rubber mix to impregnate the reinforcement cord, or the circumferential windings of cord.

According to the invention, a bead seat zone 80, formed of a rubber mix of a secant modulus of extension at 10% deformation, measured at 23° C. in accordance with Standard ASTM D 412, of from 5 to 15 MPa, and preferably between 6 and 9 MPa, and less than that of the mix 60 of the anchoring zone, is arranged radially internally to the anchoring zone, and makes it possible to separate said anchoring zone from the seat of the rim when the tire is mounted. In the example of FIG. 2, this modulus is 7.5 MPa. So as to increase the torsional rigidity of the bottom zone of the tire, the thickness of the bead seat zone 80 is reduced compared with the comparable tires of known type. Thus, said zone has a maximum radial thickness of 3.0 mm, and preferably equal to or less than 2.5 mm. In the example of embodiment of FIG. 2, the zone has a thickness of 2.2 mm.

This seat zone 80 forms a band of substantially constant thickness over at least one quarter, and preferably at least half, of the axial width of the anchoring zone.

Furthermore, as illustrated in FIG. 2, the anchoring zone comprises, in its radially lower or inner portion, a portion 81 free of circumferential cords. The anchoring zone may also comprise, in its radially inner portion, a portion 82 which is advantageously free of reinforcement structure.

As shown in FIG. 2, the portion 81 free of circumferential cords may advantageously be higher than, i.e., radially outwardly of the portion 82 free of reinforcement structure cords.

A sidewall insert 30, formed of a substantially rigid rubber composition, extends substantially radially between the region of the base of the sidewall and the shoulder region of the tire. The main function of this insert is to enable the tire to support a certain load when the tire is at low pressure, or even at zero pressure.

Although the figures illustrate an insert 30 of large dimensions, a similar function could be performed by one or more inserts of substantially different, in particular smaller, size.

In a large proportion of the sidewall, the insert 30 occupies a width in the axial direction which is greater than 50% of the total thickness of the wall of the sidewall.

Axially internally relative to the insert 30, a layer of substantially impermeable rubber composition 40 extends advantageously over substantially all the inner portion of the tire. As the impermeable layer is the innermost layer, all the other layers benefit from the barrier effect thus created. The mix 30 is advantageously based on butyl rubber. The modulus of extension of this mix is relatively low.

As illustrated in the various examples of embodiment, the layer 40 is preferably anchored in the axially inner portion of the bead. This resulting anchored portion 41 provides effective protection from any incipient cracks or separations, etc.

A layer of bonding mix 50 is advantageously arranged between the impermeable layer 40 and the insert 30. This layer is formed of a rubber composition of a modulus of extension which is substantially intermediate compared with the two types of material surrounding it: namely on one hand the impermeable layer 40, of low modulus of extension, and the insert 30, of substantially high modulus of extension. This layer may extend substantially over the entire height, i.e., radial direction of the insert 30 on each sidewall, and is interrupted in the crown zone. According to another embodiment, as illustrated in FIG. 2, the layer 50 extends from one bead to the other, including in the crown zone. According to one variant (not shown), this same layer has a greater thickness than in the other examples illustrated.

The carcass-type reinforcement structure 10 runs along the sidewall along a preferred course close to said insert 30. Thus, in FIG. 2, said structure 10 is laid axially externally relative to the insert 30 and advantageously runs in direct contact with the insert, over the major part of the course of the sidewall. At the base of the sidewall, in the zone in which the insert 30 narrows, the course of the structure 10 moves away from the insert. Advantageously, in the region of interface between the anchoring zone and the sidewall, the reinforcement structure 10 follows a course which is as direct as possible. In the example illustrated, inclination of the anchoring zone, in particular of the stacks 22, enables the whole of the anchoring zone, and of the structure portion 10 located in this zone, to be substantially aligned with the axially outer edge of the insert 30, at the base thereof, in the portion located outside the narrowing zone 31. This type of arrangement permits effective taking-up of the forces of the carcass-type reinforcement structure by the anchoring zone, without creating a zone of stress concentration.

The direct contact between the reinforcement structure and the insert makes it possible to optimise the rigidity and mechanical strength characteristics of the sidewall.

The industrial manufacture of a tire according to the invention may be performed using several types of processes. Advantageously, a principle of laying on a central core is used which permits either individual laying of the constituent elements such as the rubber mixes and the reinforcing threads (cords) or alternatively the laying of semi-finished products such as reinforced rubber lamellae.

1-8. (canceled)

9. A tire for extended-mobility travel, comprising at least one carcass-type reinforcement structure anchored on each side of said tire in a bead a base the bead adapted to be mounted on a rim seat; each bead extending substantially radially externally in the form of a sidewall which radially towards the outside joins a tread; the carcass-type reinforcement structure extending circumferentially from each bead towards the respective sidewall; a crown reinforcement; each of said sidewalls being reinforced by a sidewall insert formed of rubber composition capable of bearing a load corresponding to part of a vehicle weight in a situation in which the inflation pressure is at least substantially reduced; each of the beads furthermore comprising:
an anchoring zone permitting the reinforcement structure to be held in place and comprising an anchoring rubber mix and a series of circumferential cord windings arranged in said rubber mix on both sides of the end portion of the reinforcement structure, and a bead seat zone arranged radially internally of the anchoring zone and formed of a rubber mix having a secant modulus of extension at 10% deformation, measured at 23° C. in accordance with Standard ASTM D 412, which is less than that of the mix of the anchoring zone, for physically separating said anchoring zone from a rim seat when the tire is mounted, said bead seat zone having a maximum radial thickness of 3.0 mm.

10. A tire according to claim 9 wherein the maximum radial thickness of the bead seat zone is equal to or less than 2.5 mm.

11. A tire according to claim 9, in which said anchoring zone comprises, in a radially lower portion thereof, a portion free of the circumferential cord windings.

12. A tire according to claim 11, in which the anchoring zone comprises, in a radially lower portion thereof, a portion free of the carcass-type reinforcement structure.

13. A tire according to claim 12, in which the portion free of circumferential cord windings extends radially a greater distance than the portion free of carcass-type reinforcement structure.

14. A tire according to claim 9, in which the anchoring zone comprises, in a radially lower portion thereof, a portion free of the carcass-type reinforcement structure.

15. A tire according to claim 14, in which said bead seat zone forms a band of substantially constant thickness over more than one quarter of an axial width of the anchoring zone.

16. A tire according to claim 9, in which said rubber mix of the anchoring zone is formed of a rubber composition having a secant modulus of extension ME10 at 10% deformation, measured at 23° C. in accordance with Standard ASTM D 412, of greater than 10 MPa.

17. A tire according to claim 16 in which said secant modulus of extension is between 30 and 60.

18. A tire according to claim 16, in which said rubber mix of the bead seat zone is formed of a rubber composition having a secant modulus of extension ME10 at 10% deformation, measured at 23° C. in accordance with Standard ASTM D 412, of from 5 to 15 MPa.

19. A tire according to claim 9 in which the inflation pressure is substantially reduced or zero; each of the beads furthermore comprising:
an anchoring zone permitting the reinforcement structure to be held in place and comprising an anchoring rubber mix and a series of circumferential cord windings arranged in said rubber mix on both sides of the end portion of the reinforcement structure, and a bead seat zone arranged radially internally of the anchoring zone and formed of a rubber mix having a secant modulus of extension at 10% deformation, measured at 23° C. in accordance with Standard ASTM D 412, and being less than that of the mix of the anchoring zone, for physically separating said anchoring zone from a rim seat when the tire is mounted, said bead seat zone having a maximum radial thickness of 3.0 mm.

20. A tire according to claim 19 in which the secant modulus of extension of the rubber composition of the bead seat zone is between 6 and 9.

21. A tire according to claim 19 in which the secant modulus of extension of the rubber composition of the anchoring zone is between 30 and 60.

22. A tire according to claim 9 in which said sidewall insert is arranged axially internally relative to said reinforcement structure.
